(19) United States
(12) Patent Application Publication
(10) Pub. No.: US 2008/0053918 A1
(43) Pub. Date: Mar. 6, 2008

(54) Systems and methods for controlling resistivity and pH levels in a coolant delivery system

(75) Inventor: Christopher John Murphy, Lakewood, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Northrop Grumman Corporation

(21) Appl. No.: 11/513,734

(22) Filed: Aug. 31, 2006

(51) Int. Cl. C02F 1/00; B01J 49/00; C02F 1/72

(52) U.S. Cl. 210/743; 210/759; 210/673

(57) ABSTRACT

Systems and methods for controlling resistivity and pH levels in a coolant delivery system are provided. The coolant delivery system can employ a first ion introduction element that introduces hydrogen ions into a coolant of the coolant delivery system, and a second ion introduction element that introduces hydroxide ions into the coolant. An amount of hydrogen ions and an amount of hydroxide ions introduced into the coolant can be selected to substantially maintain an acceptable resistivity and pH level of the coolant.

### TECHNICAL FIELD

The present invention relates generally to coolant systems, and more particularly to a systems and methods for controlling resistivity and pH levels in a coolant delivery system.

### BACKGROUND

Many industrial coolant processes have specific requirements for conductivity/resistivity. The use of highly resistive water (deionized) for coolant permits direct contact cooling of high voltage devices, for example, such as diode pumped solid state lasers, which are typically cooled by a flow of water or ethylene glycol water (EGW) mixture. Although the deionization process provides the desirable highly resistive water, the deionization process also undesirably increases the acidity of the coolant. The increase in acidity of the coolant can lead to corrosion if metallic piping and/or metallic heat exchangers are employed in the coolant process. Additionally, carbon dioxide from the air dissolves into the coolant increasing the acidity creating a corrosive solution that will interact with the metallic piping and/or metallic heat exchangers. The corrosion of the metallic piping and/or metallic heat exchangers affects the heat transfer properties of the materials in addition to introducing particulate contamination into the coolant both affecting the coolant process. In applications requiring specific set temperatures, changes in the heat transfer capabilities of the heat exchangers can severely affect the operation of the high voltage device.

### SUMMARY

In one aspect of the invention, a coolant delivery system is provided. The coolant delivery system can comprise a coolant delivery line that delivers coolant to a high power device, a first ion introduction element that introduces hydrogen ions into the coolant and a second ion introduction element that introduces hydroxide ions into the coolant. An amount of hydrogen ions and an amount of hydroxide ions introduced into the coolant can be selected to substantially maintain an acceptable resistivity and PH level of the coolant.

In another aspect of the invention, a system for delivering coolant to a high power device is provided. The system can comprise a coolant delivery line that delivers coolant from a coolant reservoir to a high power device, and a feedback path that diverts a portion of coolant from the coolant delivery line back to the coolant reservoir. The feedback path can comprise means for introducing hydrogen ions into the coolant, means for introducing hydroxide ions into the coolant, and means for adjusting a ratio of an amount of coolant to the means for introducing hydrogen ions and an amount of coolant to the means for introducing hydroxide ions to substantially maintain an acceptable resistivity and pH level of the coolant.

In yet a further aspect of the present invention, a method is provided for controlling resistivity and pH levels in a coolant delivery system. The method can comprise measuring resistivity and pH level of a coolant in the coolant delivery system, performing at least one of increasing an introduction of hydrogen ions into the coolant and decreasing an introduction of hydroxide ions into the coolant, if the measured resistivity is below a first threshold, and performing at least one of increasing an introduction of hydroxide ions into the coolant and decreasing an introduction of hydrogen ions into the coolant, if the measured pH level is below a second threshold.

### BRIEF DESCRIPTION OF THE DRAWINGS

FIG. 1 illustrates block schematic diagram of a coolant delivery system in accordance with an aspect of the present invention.

FIG. 2 illustrates a methodology for controlling resistivity and pH levels in a coolant delivery system in accordance with an aspect of the present invention.

FIG. 3 illustrates another methodology for controlling resistivity and pH levels in a coolant delivery system in accordance with an aspect of the present invention

### DETAILED DESCRIPTION

The present invention relates to systems and methods for controlling resistivity and pH levels in a coolant delivery system. The coolant delivery system can employ a first ion introduction element that introduces hydrogen ions into a coolant of the coolant delivery system, and a second ion introduction element that introduces hydroxide ions into the coolant. An amount of hydrogen ions and an amount of hydroxide ions introduced into the coolant can be selected to substantially maintain an acceptable resistivity and pH level of the coolant.

In one aspect of the invention, the coolant delivery system employs a hydrogen (H—) ion exchange cartridge (e.g., a cation exchange cartridge, mixed bed deionization exchange cartridge, etc.) in conjunction with a hydroxide (OH—) ion exchange cartridge (e.g., an anion exchange cartridge) to control the resistivity and the pH level of the coolant in the coolant delivery system. In another aspect of the invention, a portion of the coolant is diverted from a main loop through a feedback loop through a parallel configuration of a hydrogen ion exchange cartridge and a hydroxide ion exchange cartridge. The flow of coolant is balanced between the hydrogen ion exchange cartridge and the hydroxide ion exchange cartridge to substantially maintain an acceptable resistivity (e.g., about 1 MegaOhm) and pH level (e.g., between about 7 and about 9) of the coolant.

The present invention provides for maintaining of an acceptable pH level (i.e., more basic than acidic) of the coolant that increases the life of coolant lines and heat exchangers fabricated from metals (e.g., copper, aluminum, etc.), while still providing for acceptable resistivity of the coolant. The present examples will be illustrated with respect to ion exchange cartridges being employed as ion introducing elements, however, other types of ion introducing elements can be employed to carry out the present invention.

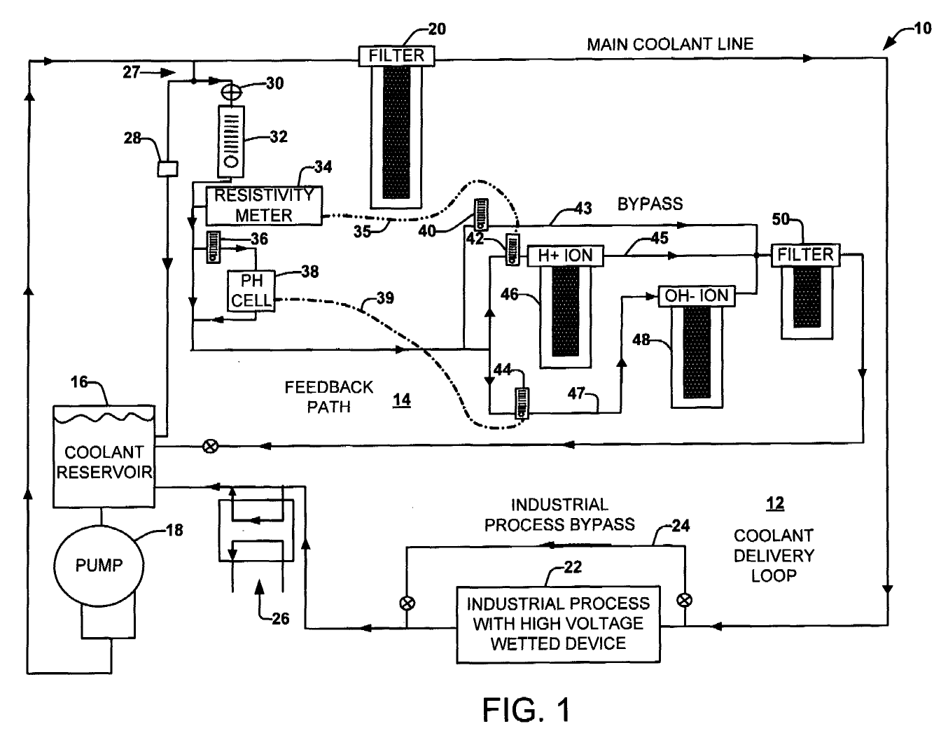

FIG. 1 illustrates a coolant delivery system 10 for providing a coolant to a high power device in accordance with an aspect of the present invention. The high power device can be, for example, a laser system or components of a laser system, such as a diode for pumping a laser or an optical amplifier. The coolant delivery system 10 includes a main coolant delivery loop 12 that provides coolant to an industrial process with at least one wetted high voltage device 22. The coolant can be in the form of water, an ethylene glycol/water (EGW) solution or some other form of coolant. The industrial process may include a wetted high power device, a laser system, for example, diode(s), optical amplifier or other processes that require temperature control. The main coolant delivery loop 12 includes a heat exchanger 26 downstream of the industrial process with the at least one wetted high voltage device 22. The coolant is provided to a coolant reservoir 16, and pumped through a main coolant delivery line 13 by a pump 18. The pump 18 delivers the coolant to the industrial process with the at least one wetted high power device 22 through a particle filter 20 that removes particle contaminants from the coolant. An industrial process bypass 24 is provided to bypass at least a portion of the coolant around the industrial process 22, for example, for adjusting the temperature of the coolant, or during a coolant rechill time period.

It is to be appreciated that the example of the main coolant delivery loop 12 of FIG. 1 can include other components, such as filters, a reservoir or accumulator upstream of the pump 18, and various other components.

The coolant delivery system 10 also includes a feedback path 14 for coolant resistivity and pH control. A portion of coolant is tapped from the main coolant delivery line 13 to the feedback path 14 via a T-connector 27. The feedback path 14 can be disabled by turning on a flow valve 28 having a first path to the coolant reservoir 16, and closing a ball valve 30 to the feedback path 14. In normal feedback operation, the flow valve 28 is off, and the coolant is diverted through the feedback path 14 via the ball valve 32 through a rotometer 32. The rotometer 32 limits the flow rate through the feedback loop 14, for example, to about 2 Liters/Minute or about 30 Gallons/Hour.

A resistivity meter 34 is coupled to the feedback path 14 to measure the resistivity of the coolant and may generate a signal 35 indicative of the resistivity of the coolant. A flow meter 36 and pH cell 38 are coupled in parallel with the feedback path 14. The flow meter 36 limits the flow of coolant through the pH cell 38, for example, to about 0.3 Liter/Minute. The pH cell 38 measures the pH level of the coolant, and may generate a signal indicative of the pH level of the coolant. The feedback path 14 then splits into three separate parallel paths. A first path is a bypass path 43 and includes a first flow valve/meter 40 for controlling the flow of coolant through the bypass path 43. A second path is a hydrogen ion introducing path 45 and includes a second flow valve/meter 42 for controlling the flow of coolant to a hydrogen ion exchange cartridge 46 (e.g., cation cartridge, mixed bed deionization cartridge). A third path is a hydroxide ion introducing path 47 and includes a third flow valve/meter 44 for controlling the flow of coolant to a hydroxide ion exchange cartridge 48. The first path, the second path, and the third path are rejoined together and the coolant provided to a particle filter 50 for removing particulates caused by the introducing of hydrogen ions and hydroxide ions into the coolant. The coolant is then delivered back to the coolant reservoir 16.

The hydrogen ion exchange cartridge 46 removes metal ions (cations) from the coolant increasing the resistivity while introducing H+ ions into the coolant thereby increasing the coolant acidity. The hydroxide ion exchange cartridge 48 removes anions from the coolant decreasing the resistivity while introducing OH— ions into the coolant to decrease the acidity of the coolant. The second and third flow valve/meters 42 and 44 are adjusted to control the flow rate, or amount of coolant through each respective path based on the resistivity measured by the resistivity meter 34 and the pH level of the coolant measured by the pH cell 38, respectively. The flow rate setting of the second and third flow valve/meters 42 and 44 can be set manually, or automatically based on control adjustment signals (e.g., 35 and 39) indicative of the resistivity measured by the resistivity meter 34 and the pH level of the coolant measured by the pH cell 38. The coolant system 10 can reach equilibrium and substantially maintain an acceptable resistivity (e.g., about 1 MegaOhm) and pH level setting (e.g., between about 7 and about 9) in as little as a four to eight hours.

It is to be appreciated that a single bidirectional valve can be employed in place of the second and third flow valve/meters 42 and 44, with an aggregation of the resistivity and pH level measurements being employed to determine the flow rate or amount of coolant flowing to the hydrogen ion exchange cartridge 46 and the hydroxide ion exchange cartridge 48. Furthermore, although the example of FIG. 1 illustrates flow to the hydrogen ion exchange cartridge 46 being based on resistivity measurements, and flow to the hydroxide ion exchange cartridge 48 being based on pH level measurements, it is to be appreciated that resistivity of the coolant can be increased with either an increase in the introducing of hydrogen ions or a decrease in the introducing of hydroxide ions. Additionally, it is to be appreciated that pH level of the coolant can be increased with either an increase in the introducing of hydroxide ions or a decrease in the introducing of hydrogen ions. Therefore, all such configurations of measurements and valve control that substantially maintain an acceptable resistivity and pH level setting have been contemplated and are covered by the appended claims.

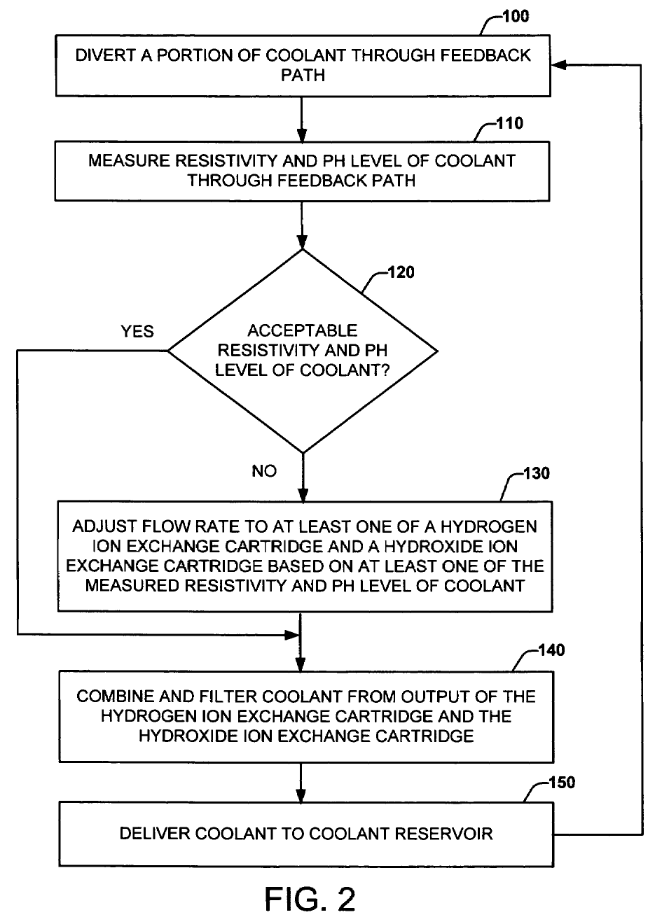

FIG. 2 illustrates a methodology for controlling resistivity and pH levels in a coolant delivery system in accordance with an aspect of the present invention. The methodology begins at 100 where a portion of coolant from the coolant delivery system is diverted through a feedback loop. The portion of coolant can be diverted from a main coolant delivery loop, or from a coolant reservoir. At 110, resistivity and pH level of coolant through the feedback loop is measured. At 120, the methodology determines if desired resistivity and pH level of the coolant has been achieved. If the desired resistivity and pH level of the coolant has been achieved (YES), the methodology proceeds to 140. If the desired resistivity and pH level of the coolant has not been achieved (NO), the methodology proceeds to 130. At 130, flow rate to at least one of a hydrogen ion exchange cartridge and a hydroxide ion exchange cartridge is adjusted based on the measured resistivity and pH level of the coolant. The hydrogen ion exchange cartridge introduces H+ ions into the coolant to increase the resistivity of the coolant, thus also increasing the acidity of the coolant. The hydroxide ion exchange introduces OH— ions into the coolant to decrease the acidity of the coolant, thus also decreasing the resisitivity of the coolant. The methodology then proceeds to 140.

At 140, the coolant from the hydrogen ion exchange cartridge and the coolant from the hydroxide ion exchange cartridge are combined, and particles from the combined coolant are removed, for example, employing a particle filter. The removal of the particles is employed, since the exchange cartridges are typically mixed resin devices that can introduce particles into the coolant. The methodology then proceeds to 150 to deliver the combined, filtered coolant to the coolant reservoir. The methodology then returns to 100 to repeat the methodology, skipping the adjustment of the flow rate box at 130 once the coolant has reached equilibrium and established an acceptable resistivity and PH level.

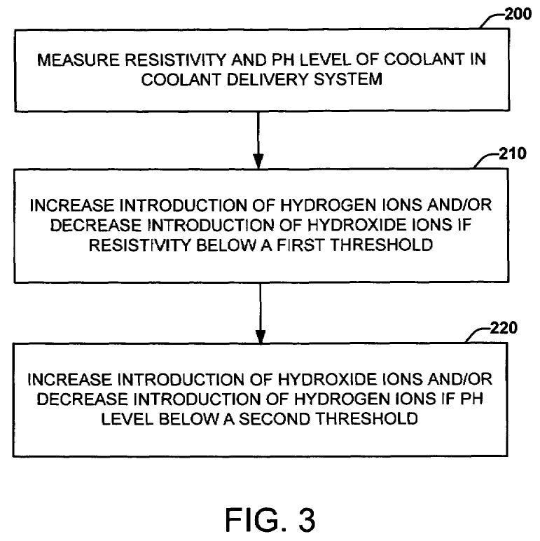

FIG. 3 illustrates another methodology for controlling resistivity and pH levels in a coolant delivery system in accordance with an aspect of the present invention. The methodology begins at 200 where resistivity and pH level of coolant in the coolant delivery system is measured. At 210, an introduction of hydrogen ions and/or decrease of an introduction of hydroxide ions is performed if the resistivity of the coolant falls below a first threshold. At 220, an introduction of hydroxide ions and/or decrease of an introduction of hydrogen ions is performed if the pH level of the coolant falls below a second threshold.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A coolant delivery system comprising:
a coolant delivery line that delivers coolant to a high power device;
a first ion introduction element that introduces hydrogen ions into the coolant; and
a second ion introduction element that introduces hydroxide ions into the coolant, wherein an amount of hydrogen ions and an amount of hydroxide ions introduced into the coolant are selected to substantially maintain an acceptable resistivity and PH level of the coolant.

2. The system of claim 1, wherein the first ion introduction element is one of a cation exchange cartridge and a mixed bed deionization exchange cartridge and the second ion introduction element is an anion exchange cartridge.

3. The system of claim 1, further comprising:
a first flow valve that controls an amount of coolant that flows through the first ion introduction element; and
a second flow valve that controls an amount of coolant that flows through the second ion introduction element, wherein the amount of coolant that flows through a given ion introduction element determines the amount of ions introduced into the coolant by the given ion introduction element.

4. The system of claim 3, further comprising a resistivity meter that measures the resistivity of the coolant and a pH cell that measures the pH level of the coolant, at least one of the first flow valve and the second flow valve being set based on at least one of the measured resistivity and the measured pH level of the coolant.

5. The system of claim 4, wherein the at least one of the first flow valve and the second flow valve is automatically adjusted based on at least one of the measured resistivity and the measured pH level of the coolant.

6. The system of claim 1, wherein the first ion introduction element is a hydrogen ion exchange cartridge and the second ion introduction element is a hydroxide ion exchange cartridge.

7. The system of claim 6, wherein the hydrogen ion exchange cartridge is configured in parallel with the hydroxide ion exchange cartridge in a feedback path, wherein at least a portion of coolant diverted from the coolant delivery line through the feedback path splits between the hydrogen ion exchange cartridge and the hydroxide ion exchange cartridge based on a determined ratio and is recombined at outputs of the hydrogen ion exchange cartridge and the hydroxide ion exchange cartridge.

8. The system of claim 7, further comprising a particle filter coupled between outputs of the hydrogen ion exchange cartridge and the hydroxide ion exchange cartridge, and a coolant reservoir.

9. The system of claim 8, wherein the feedback path further comprises a resistivity meter that measures the resistivity of the coolant and a pH cell that measures the pH level of the coolant and a first flow valve that controls an amount of coolant flowing to the hydrogen ion exchange cartridge and a second flow valve that controls an amount of coolant flowing to the hydroxide ion exchange cartridge, at least one of the first flow valve and the second flow valve being set based on at least one of the measured resistivity and the measured pH level of the coolant.

10. The system of claim 1, wherein the high power device is at least one component of a laser system.

11. A system for delivering coolant to a high power device, the system comprising:
a coolant delivery line that delivers coolant from a coolant reservoir to a high power device; and
a feedback path that diverts a portion of coolant from the coolant delivery line back to the coolant reservoir, the feedback path comprising:
means for introducing hydrogen ions into the coolant;
means for introducing hydroxide ions into the coolant; and
means for adjusting a ratio of an amount of coolant to the means for introducing hydrogen ions and an amount of coolant to the means for introducing hydroxide ions to substantially maintain an acceptable resistivity and pH level of the coolant.

12. The system of claim 11, wherein the feedback path further comprises means for measuring resistivity of the coolant and means for measuring pH level of the coolant, the ratio being adjusted based on at least one of the measured resistivity and the measured pH level.

13. The system of claim 11, wherein the means for adjusting the ratio comprises a first means for adjusting an amount of coolant to the means for introducing hydrogen ions and a second means for adjusting an amount of coolant to the means for introducing hydroxide ions.

14. The system of claim 11, wherein the feedback path further comprises means for removing particles from outputs of the means for introducing hydrogen ions and the means for introducing hydroxide ions.

15. The system of claim 11, wherein the means for introducing hydrogen ions is a hydrogen ion exchange cartridge and the means for introducing hydroxide ions is a hydroxide ion exchange cartridge.

16. A method for controlling resistivity and pH levels in a coolant delivery system, the method comprising:
measuring resistivity and pH level of a coolant in the coolant delivery system;
performing at least one of increasing an introduction of hydrogen ions into the coolant and decreasing an introduction of hydroxide ions into the coolant, if the measured resistivity is below a first threshold; and
performing at least one of increasing an introduction of hydroxide ions into the coolant and decreasing an introduction of hydrogen ions into the coolant, if the measured pH level is below a second threshold.

17. The method of claim 16, wherein the increasing and decreasing an introduction of hydrogen ions comprises increasing and decreasing a flow rate of coolant through a hydrogen ion exchange cartridge and increasing and decreasing an introduction of hydroxide ions comprises increasing and decreasing a flow rate of coolant through a hydroxide ion exchange cartridge.

18. The method of claim 17, wherein the hydrogen ion exchange cartridge is one of a cation exchange cartridge and a mixed bed deionization exchange cartridge and the hydroxide ion exchange cartridge is an anion exchange cartridge.

19. The method of claim 17, further comprising:
diverting a portion of coolant from a coolant delivery line that delivers coolant from a coolant reservoir to a high power device for measuring resistivity and pH level of the coolant;
splitting at least a portion of the diverted portion of coolant between the hydrogen ion exchange cartridge and the hydroxide ion exchange cartridge based on a determined ratio;
combining and filtering coolant output from the hydrogen ion exchange cartridge and the hydroxide ion exchange cartridge; and
delivering the coolant to the coolant reservoir.

20. The method of claim 19 further comprising continuously adjusting the ratio of coolant split between the hydrogen ion exchange cartridge and the hydroxide ion exchange cartridge based on at least one of the measured resistivity and pH level, until an acceptable resistivity and PH level of the coolant is obtained.
